(19) United States
(12) Patent Application Publication
(10) Pub. No.: US 2009/0261163 A1
(43) Pub. Date: Oct. 22, 2009

(54) ELECTRONIC DEVICE AND INFORMATION TRANSMISSION METHOD THEREOF

(75) Inventor: CHUN-HUNG CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/262,177

(22) Filed: Oct. 30, 2008

(30) Foreign Application Priority Data
Apr. 22, 2008 (CN) 200810301260.7

(51) Int. Cl. G06K 5/00

(52) U.S. Cl. 235/382

(57) ABSTRACT

An electronic device for transmitting control data according to an external user card includes a control interface, a switching module, and an information center. The information center includes a detection module, a verification module, a control module, and an information transmission module. The detection module detects insertion of the user card. The verification module verifies whether the user card is valid. The control module determines whether the switching module is activated based on the verification of the user card. The information transmission module transmits control data to the control interface when the switching module has been activated. A method for an electronic device for transmitting control data is also provided.

### BACKGROUND

1. Field of the Invention

The disclosure relates to network communications, and particularly to an electronic device and information transmission method thereof.

2. Description of related art

With the development of network communication technology, practical applications of electronic devices, such as set-top boxes and cable modems, are becoming increasingly popular. Typically, control data is built into the electronic devices for driving relevant hardware thereof to operate normally. For the purpose of convenience, the control data is configured so that authorized personnel can directly access and reset the data through a control interface. Consequently, this may also allow non-professionals to easily access or retrieve the control data through the control interface.

FIG. 4 shows a schematic diagram of such an electronic device, in which data transfer to and from a central processing unit 200 thereof is accomplished through a control interface 300, or directly with the central processing unit 200 itself. In the event of only simple input is required, such as passwords or user names, input can be made directly to the central processing unit 200.

Such control data transfer with the aforementioned electronic device provides convenience to the professional repairer, and at the same time, allows non-professionals to easily obtain the control data as well. Unauthorized personnel can alter or destroy the control data due to misuse, subsequently preventing the electronic device from operating normally. Therefore, a simple and secure way for transmitting control data of electronic devices is desired, which allows authorized personnel to easily access the control data and prevents access to the control data from unauthorized users.

### SUMMARY

The disclosure provides an electronic device providing convenient and secure transmission of control data requiring a verified user card for data exchange. The electronic device comprises a control interface, a switching module, and an information center. The control interface allows data exchange between the electronic device and a user. The switching module is connected to the control interface. The information center is connected to the switching module, transmitting control data thereto via the switching module. The information center comprises a detection module, a verification module, a control module and an information transmission module. The detection module detects whether a user card has been connected to the electronic device and whether the card is valid, the control module determines whether the switching module is activated according to the verification of the user card, and the information transmission module transmits the control data to the control interface through the switched on state of the switching module.

The disclosure further provides a method for transmitting control data via the electronic device. The method comprises detecting whether a user card is connected to an electronic device, verifying whether the user card is valid, activating a switching module if the user card is valid, and transmitting control data to a control interface through the switching module.

Other advantages and novel features of the disclosure will become more apparent from the following detailed descriptions of preferred embodiments when taken in conjunction with the accompanying drawings, in which:

### BRIEF DESCRIPTION OF THE DRAWINGS

FIG. 1 is a schematic diagram of an electronic device in accordance with an exemplary embodiment of the disclosure;

FIG. 2 is a flowchart of a method for transmitting control data in accordance with the disclosure;

FIG. 3 is a detailed flowchart of FIG. 2; and

FIG. 4 is a schematic diagram of an electronic device transmitting control data.

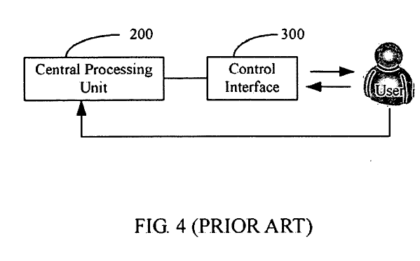

### DETAILED DESCRIPTION OF THE EMBODIMENTS

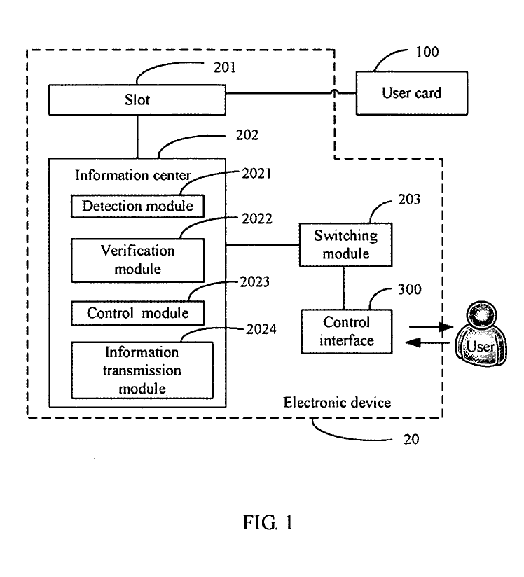

Referring to FIG. 1, the functional module of an electronic device 20 in accordance with the disclosure is shown, in which electronic device 20 comprises a slot 201, an information center 202, a switching module 203, and a control interface 300. The electronic device 20 provides a convenient and secure method of control data exchange with the control interface 300 following insertion of a user card 100 which provides access to control data via the control interface 300. The user card 100 is inserted into the electronic device 20, which detects the insertion and determines whether the user card is valid. If so, the switching module 203 is activated and control data is transmitted to the control interface 300 therethrough.

The electronic device 20 may be any terminal device requiring configuration or maintenance, such as set-top boxes and cable modems. The user card 100 can be an intelligent memory card, a smart flash card, or other intelligent card storing user data, and being accessible by the electronic device 20.

The slot 201 bridges the information center 202 and the user card 100 to establish communication therebetween. The information center 202 is not limited to such communication with the user card 100 and can bridge the communication using other technologies, such as Bluetooth or infrared protocols, while remaining well within the scope of the disclosure.

While here, the information center 202 is a central processing unit (CPU), other processing units in the electronic device 20 can be used.

The information center 202, connected to the switching module 203, provides exchange of control data to the control interface 300 thereby. As shown, the information center 202 comprises a detection module 2021, a verification module 2022, a control module 2023, and an information transmission module 2024.

When the user card 100 has been inserted into the slot 201, the detection module 2021 receives a high voltage level transmitted from a specific pin of the user card 100, which indicates safe and complete connection thereof to the electronic device 20. Secure communication is thus established between the information center 202 and the user card 100.

In other embodiments of the disclosure, the detection module can determine connection of the user card to the electronic device when receiving a low voltage level transmitted from the user card.

The verification module 2022 verifies whether the user card 100 detected by the detection module 2021 is valid, based on identification information stored thereon.

The control module 2023 transmits an instruction to activate the switching module 203 if the identification information on the user card 10 is valid, and otherwise transmits no instruction.

The switching module 203 is connected to the information center 202 and is activated according to the instruction transmitted from the control module 2023. While here, the switching module 203 is intelligent, and may be activated or deactivated according to various intelligent instructions, commands or control signals, the switching module can be a software switching module, activated or deactivated according to software instructions or commands.

The switching module 203 is located inside the electronic device as an intelligent switch that can be activated or deactivated according to signals, commands or instructions. In other embodiments, the switching module may be an intelligent software switching module embedded in the central processing unit of the electronic device executing on/off function according to software control commands or instructions. The switching module is not limited to the modules described, and can be other types of switch circuit, device, or apparatus that can be activated or deactivated according to special control or electrical signal.

The information transmission module 2024 transmits the control data to the control interface 300 when the switching module 203 has been activated, subsequently providing access to the control data via the control interface 300.

The control interface 300 is connected to the switching module 203 and provides the control data transmitted from the information center 202. Correspondingly, the electronic device 20 is configurable and adjustable via the control interface 300 based on the presented control data.

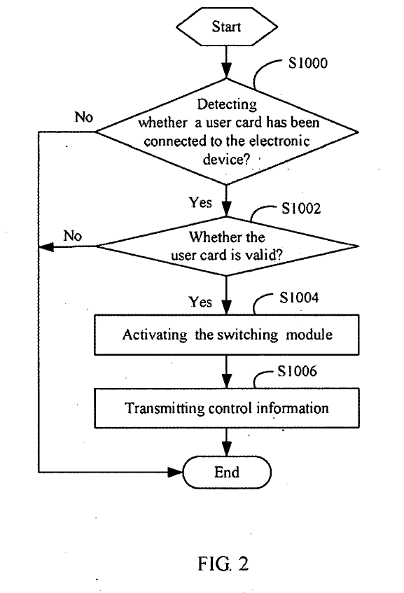

FIG. 2 is a flowchart of a method for transmitting control data in accordance with the disclosure. In step S1000, the detection module 2021 detects whether the user card 100 has been connected to the electronic device 20 by receipt of a high voltage level transmitted from a specific pin of the user card 100, and confirms that communication has been established between the information center 202 and the user card 100.

In step S1002, the verification module 2022 verifies whether the user card 100 detected by the detection module 2021 is valid. Specifically, the verification module 2022 reads and verifies identification information stored in the user card 100, and determines whether the identification information is valid.

In step S1004, the control module 2023 activates the switching module 203 if the identification information in the user card 100 is valid, transmitting an activation instruction thereto. The switching module 203 may alternatively be activated according to other intelligent instructions, commands and control signals.

In step S1006, the information transmission module 2024 transmits the control data to the control interface 300 via the activated switching module 203. The information transmission module 2024 transmits the control data to the control interface 300 via the switching module 203 when the switching module 203 is activated, subsequently providing access to the control data via the control interface 300.

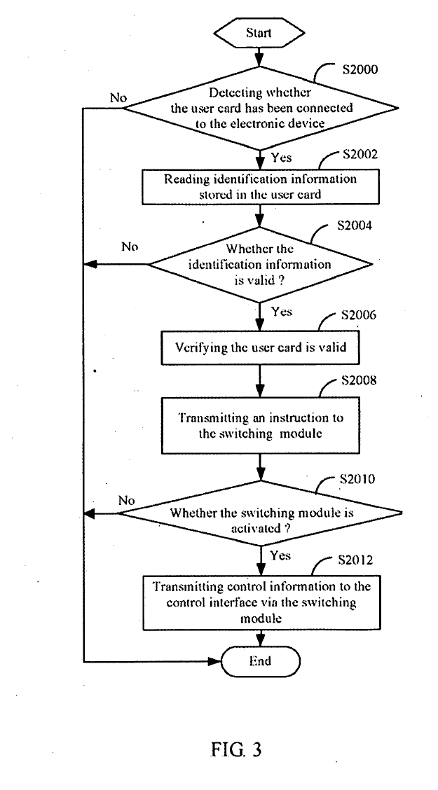

FIG. 3 is a detailed flowchart of FIG. 2. In step S2000, the detection module 2021 detects whether the user card 100 has been connected to the electronic device 20 and confirms communication is established between the user card 100 and the electronic device 20, via receipt of a high voltage level transmitted from a specific pin of the user card 100, and secure communication is established between the information center 202 and the user card 100.

Alternatively, the detection module can detect connection of the user card by receipt of a low voltage or other voltage level transmitted therefrom.

In step S2002, the verification module 2022 reads identification information stored in the user card 100 via the slot 201.

In step S2004, the verification module 2022 determines whether the identification information stored in the user card 100 is valid, and, if so, S2006 is executed. If not, the electronic device rejects the user card.

In step S2006, the verification module 2022 verifies the user card 100 is valid and sends the verification results to the control module 2023.

In step S2008, the control module 2023 transmits an instruction to the switching module 203 to activate the switching module 203. In this exemplary embodiment, the control module 2023 transmits an instruction to the switching module 203 when it receives verification that the user card 100 is valid. Consequently, the switching module 203 is activated according to the instruction. In this exemplary embodiment, the switching module 203 is an intelligent switch, which can be activated or deactivated according to various intelligent instructions, commands or control signals. In other embodiments, the switching module 203 may be a software switching module, which is activated or deactivated according to software instructions or commands.

In step S2010, the control module 2023 checks whether the switching module 203 is activated. In this exemplary embodiment, the switching module 203 is activated based on the switched on instruction, therefore, the control module 2023 needs to confirm whether the switching module 203 is activated after the instruction has been transmitted.

In step S2012, the information transmission module 2024 transmits the control data to the control interface 300 when the switching module 203 is activated. The information center 202 communicates with the control interface 300 through the switching module 203, providing access to control data thereby.

In this exemplary embodiment, the switching module 203 only transmits the control data. However, the switching module 203 is equally applicable as a memory or register for storing the control data transmitted from the information transmission module 2024.

The disclosure provides a convenient and secure method of transmitting control data according to the insertion of a user card which is valid based on the identification information stored thereof. As such, authorized personnel can easily access the control data, at the same time preventing unauthorized users from accessing or retrieving the control data.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electronic device securely providing control data according to identification information stored on an external user card, comprising:
a control interface, acting as a communication interface between the electronic device and a user;
a switching module, connected to the control interface; and
an information center, connected to the switching module and transmitting the control data to the control interface through the switching module, the information center comprising:
a detection module, detecting the insertion of the external user card comprising the identification information;
a verification module, verifying whether the identification information in the external user card is valid;
a control module, activating the switching module if the identification information in the external user card is valid; and
an information transmission module, transmitting the control data to the control interface when the switching module has been activated.

2. The electronic device as claimed in claim 1, further comprising a slot bridging the information center and the external user card to establish communication therebetween.

3. The electronic device as claimed in claim 2, wherein the detection module detects insertion of the user card by receipt of voltage levels transmitted from the user card.

4. The electronic device as claimed in claim 1, wherein the verification module reads the identification information stored in the user card, and verifies whether the identification information stored in the user card is valid.

5. The electronic device as claimed in claim 1, wherein the control module further transmits an instruction to the switching module to activate the switching module.

6. An information transmission method utilized by an electronic device transmitting control data according to identification information in an external user card, the method comprising:
detecting insertion of the external user card;
verifying whether the identification information in the user card is valid;
activating a switching module if the identification information is valid; and
transmitting control data to a control interface via the switching module.

7. The information transmission method as claimed in claim 6, wherein detection further comprises:
receiving voltage levels from the user card; and
determining effective connection of the user card to the electronic device according to the received voltage levels.

8. The information transmission method as claimed in claim 7, wherein verification further comprises:
reading the identification information from the user card;
determining whether the identification information is valid; and
verifying the user card is valid if the identification information is valid.

9. The information transmission method as claimed in claim 8, wherein activation further comprises transmitting an instruction to the switching module to activate the switching module.
